(19) United States
(12) Patent Application Publication
(10) Pub. No.: US 2003/0010930 A1
(43) Pub. Date: Jan. 16, 2003

(54) Arrangement for the optical excitation of fluorescent radiation of individual specimens on a multispecimen carrier

(75) Inventor: Guenter Thorwirth, Laasdorf (DE)

Correspondence Address: Gerald H. Kiel, Esq., REED SMITH, LLP, 375 Park Avenue, New York, NY, 10152-1799, US

(73) Assignee: Jena-Optronik GmbH

(21) Appl. No.: 10/165,885

(22) Filed: Jun. 7, 2002

(30) Foreign Application Priority Data
Jun. 7, 2001 (DE) 101 27 611.7

(51) Int. Cl. G01N 21/64

(52) U.S. Cl. 250/458.1

(57) ABSTRACT

An arrangement is disclosed for reading out the fluorescent radiation of specimen carriers with a plurality of individual specimens which for purposes of exciting fluorescent radiation in selected individual specimens comprises a switchable electro-optical matrix for generating illumination which is limited in a spatially defined manner. In an arrangement for reading out the fluorescent radiation of selected individual specimens of multispecimen carriers having a switchable electro-optical matrix for generating illumination which is limited in a spatially defined manner, an optical system for imaging the electro-optical matrix on the specimen carrier, and a high-sensitivity photoreceiver for integral measurement of the fluorescent radiation of the excited individual specimens of the specimen carrier, the object of the invention, to find a novel possibility for a spatially differentiated illumination of a specimen carrier with a plurality of specimens using an electro-optical matrix which minimizes the proportion of excitation radiation contributing to the fluorescence signal in high-resolution imaging of the electro-optical matrix and the specimen carrier are inclined relative to the optical axis of the optical system and are subject to a Scheimpflug condition, and the angles of inclination of the electro-optical matrix and of the specimen carrier are selected such that the excitation radiation imaged by the light source unit on the specimen carrier is reflected in such a way that essentially no excitation radiation reaches the detection beam path.

### CROSS-REFERENCE TO RELATED APPLICATION

This application claims priority of German Application No. 101 27 611.7, filed Jun. 7, 2001, the complete disclosure of which is hereby incorporated by reference.

### BACKGROUND OF THE INVENTION

a) Field of the Invention

The invention is directed to an arrangement for reading out the fluorescent radiation of specimen carriers with a plurality of individual specimens having a switchable electro-optical matrix for stimulating or exciting fluorescent radiation in selected individual specimens for illumination which is limited in a spatially defined manner. The invention can be used in particular for pixel-exact readout of the fluorescence of biochips.

b) Description of the Related Art

Laser scanners and CCD imagers are known from analysis, particularly from the biomedical field, as optical analyzing and readout devices for biochips (biochip readers, as they are called) following the basic principles. While laser scanners scan points on a multispecimen carrier and record the fluorescent radiation induced in this way serially (consecutively) by means of a highly sensitive secondary electron multiplier (SEV or PMT=photomultiplier), CCD imagers produce an optical image of the entire specimen carrier (or substantial portions thereof) by simultaneous illumination of a plurality of (or possibly all) specimens.

In both of these reader designs, the reading out of a biochip with multiple-dye labeling, i.e., with a plurality of fluorescence markers per specimen, is realized in that the entire biochip is excited and read out successively in time with respect to the various fluorochromes. In laser scanners this is achieved in that different narrowband (laser) light sources adapted to the respective fluorochromes are switched on one after the other. In CCD imagers which are outfitted with a broadband light source, different combinations of excitation filters and blocking filters are introduced into the illumination and readout beam path one after the other.

A novel principle for optical analysis devices was described in the German Patent DE 199 14 279 C1 for reading out biochips. This reader design is wherein it combines the advantages of both of the readout principles mentioned above and enables high-sensitivity fluorescence detection with PMT without the use of lasers. The individual positions of analysis specimens, or spots, on the biochip are selectively evaluated separately through the use of a light valve in the form of an electro-optical matrix in that the intensity of the spot fluorescence is detected integrally in a measurement value for a surface which is selected (illuminated or opened to the receiver) and which can contain individual spots or groups of spots. When the biochip is to be read out in conventional fashion with a spatially differentiated excitation intensity (e.g., spot by spot), a highly precise imaging of the structured electro-optical matrix in the plane of the biochip is necessary so that the matrix, as light diaphragm, can achieve a highly precise excitation of selected spots on the biochip with an optionally selectable position and magnitude of the excitation light.

On the one hand, it is disadvantageous that the imaging of the matrix pixels must be carried out in a highly precise manner, i.e., without distortion or coma, so that the biochip spots which are to be excited are completely illuminated and adjacent spots which are not to be excited do not contribute to the integrally measured fluorescence signal due to unwanted illumination. On the other hand, telecentric objectives which can be used advantageously for this purpose do not permit an incident darkfield illumination which would be advantageous for simple separation of excitation light and fluorescent light.

### OBJECT AND SUMMARY OF THE INVENTION

It is the primary object of the invention to find a novel possibility for a spatially differentiated illumination of a specimen carrier with a plurality of specimens using an electro-optical matrix which minimizes the proportion of excitation radiation contributing to the readout signal in high-resolution imaging of the electro-optical matrix on the specimen carrier.

In an arrangement for reading out the fluorescent radiation of specimen carriers with a plurality of individual specimens which for purposes of exciting fluorescent radiation in selected individual specimens comprises a switchable electro-optical matrix for generating illumination which is limited in a spatially defined manner, an optical system for imaging the electro-optical matrix on the specimen carrier, wherein exchangeable excitation filters are arranged in the beam path in front of the specimen carrier for optimal excitation of fluorescence, and a high-sensitivity photoreceiver for integral measurement of the fluorescent radiation of the excited individual specimens of the specimen carrier, the object according to the invention is met in that the electro-optical matrix is arranged in the object plane of the optical system and the specimen carrier is arranged in the image plane, wherein the electro-optical matrix and the specimen carrier are inclined relative to the optical axis of the optical system and are subject to a Scheimpflug condition, so that the object plane and object-side principal plane as well as the image plane and image-side principal plane of the optical system have two section lines lying in the same plane parallel to the optical axis, and the angles of inclination of the electro-optical matrix and of the specimen carrier are selected such that the excitation radiation coming from the light source unit and reflected by the electro-optical matrix and imaged on the specimen carrier by the optical system is reflected at the specimen carrier in such a way that essentially no excitation radiation reaches the detection beam path.

The imaging optical system advantageously comprises two identically constructed objectives which are arranged on the same optical axis so as to be mirror-symmetric with respect to an aperture diaphragm plane, and the electro-optical matrix and the specimen carrier are arranged in a mirror-symmetric manner with respect to the two-part optical system. The symmetric optical system advisably has an imaging beam path which is telecentric on both sides and is accordingly free from coma and distortion. For this reason, the optical imaging is extensively insensitive to defocusing which would otherwise lead to an altered imaging scale. Two high-resolution, rapid, infinity-corrected partial objectives, e.g., camera objectives, are preferably used as an optical system. Based on the preference for incident darkfield illumination of the specimen carrier, the electro-optical matrix can advisably be a reflection liquid crystal matrix. In a particularly advantageous manner, a digital-mechanical micromirror matrix (DMD) comprising a plurality of elementary mirrors is used as electro-optical matrix. Each of the elementary mirrors, as a unit, has a defined tilting angle for the reflection of light when switching to bright and another defined tilting angle for cutting out the radiation when switching to dark, and when the elementary mirrors are switched to bright the mirror matrix is oriented to the angle of inclination for adhering to the Scheimpflug condition, i.e., when the elementary mirrors are switched to bright the excitation bundle reflected by the digital micromirror matrix is directed parallel to the optical axis in the optical system and when the elementary mirrors are switched to dark the reflected excitation bundle is directed appreciably outside the objective aperture.

It has proven particularly advantageous for illumination and readout of the specimen carrier when a beam splitter is arranged in the imaging beam path between the optical system and the specimen carrier, wherein the imaging beam path is directed to the specimen carrier in an angled manner, the excitation radiation is coupled out of the angled imaging beam path by reflection at the specimen carrier due to the inclination of the specimen carrier, and the excited fluorescent radiation can be picked up by the detector unit through the beam splitter.

In an equivalent variant, a beam splitter is advisably arranged in the imaging beam path between the optical system and the specimen carrier, the imaging beam path being directed along the optical axis to the specimen carrier, the excitation radiation is coupled out of the angled imaging beam path by reflection at the specimen carrier due to the inclination of the specimen carrier, and the excited fluorescent radiation is deflected by the beam splitter and can be recorded by the detector unit. In both variants, a dichroic beam splitter can advantageously be used. In the first variant, the beam splitter reflects the excitation radiation and is transparent for fluorescent radiation; but in the second variant the beam splitter is transparent to the excitation radiation and reflects the fluorescent radiation. Accordingly, an additional separation of the excitation radiation and fluorescent radiation is provided. Further, a conventional blocking filter for scattered excitation light is arranged after the beam splitter in the detection beam path for the fluorescent radiation.

In order to realize the illumination unit and electro-optical matrix in a simple manner, the construction design of a conventional multimedia projector is advantageously used and the optical system is used instead of a projection lens of the projector. The inclination of the electro-optical matrix relative to the optical system is adjusted by means of the inclination of the optical system relative to the conventional position of the eliminated projection lens, and the specimen carrier which has a corresponding inclination relative to the electro-optical matrix in accordance with the Scheimpflug condition is arranged on the optical axis of the optical system.

For evaluation of specimen carriers provided with only one fluorescence marker, a filter wheel which is typically present in the illumination unit of the multimedia projector described above is advisably removed from the beam path of the illumination unit.

For evaluation of specimen carriers which are marked multiple times with fluorescence markers, a filter wheel which is typically present in the illumination unit (1) of the multimedia projector is advisably outfitted with different excitation filters, wherein the different excitation filters are rotated successively into the beam path in a controlled cycle and a multiband blocking filter is to be inserted in front of the detector unit in the detection beam path. The filter wheel advantageously has a rotating speed such that a complete revolution is carried out synchronous with a switching state of the electro-optical matrix, and the readout of the detector unit is synchronized with individual filter states of the filter wheel in such a way that a series of measurements which are generated for identical individual specimens with different excitation filters is recorded in the detector unit.

The invention is based on the basic idea of combining the advantages of high-resolution distortion-free imaging by means of telecentric objectives with an advantageous incident darkfield illumination for point-exact excitation of individual specimens on specimen carriers with a plurality of specimens (particularly medical diagnostic chips with several hundred spots).

It is well known that telecentric imaging realized by a symmetrically constructed optical system has few optical aberrations and would therefore be very well-suited to a spatially highly resolved excitation of a multispecimen carrier. However, symmetric imaging optics of this kind usually have a radiation incidence in the image plane of the optical system that is similar to brightfield illumination.

Therefore, the combination of a spatially highly resolved excitation (particularly without coma) of a multispecimen carrier with distortionless imaging of the electro-optical matrix in the specimen carrier plane and a radiation incidence in the specimen carrier plane analogous to darkfield illumination requires an oblique incidence of the excitation bundle, which conflicts with distortion-free imaging of the illumination matrix. The surprising solution consists in that the illumination beam path is formed as a symmetrically constructed optical system with the electro-optical matrix and specimen carrier inclined in opposite directions in relation to the optical axis of the imaging system used for illumination, so that a darkfield illumination is realized using a kind of Scheimpflug rectification.

The arrangement according to the invention permits imaging almost entirely without coma or distortion in an incident darkfield illumination of the specimen carrier which virtually eliminates the proportion of excitation radiation contributing to the readout signal with highly resolved imaging of the electro-optical matrix on the specimen carrier.

The invention will be described more fully in the following with reference to embodiment examples.

### BRIEF DESCRIPTION OF THE DRAWINGS

In the drawings:

FIG. 1 illustrates the basic principle of the invention;

FIG. 2 is a schematic view of the arrangement, according to the invention, with a schematic telecentric imaging beam path;

FIG. 3 shows a preferred construction of the arrangement, according to the invention, with a schematic view of the illumination beam path; and

FIG. 4 shows a detailed view of the arrangement of the electro-optical matrix using a DMD (digital micromirror device).

### DESCRIPTION OF THE PREFERRED EMBODIMENTS

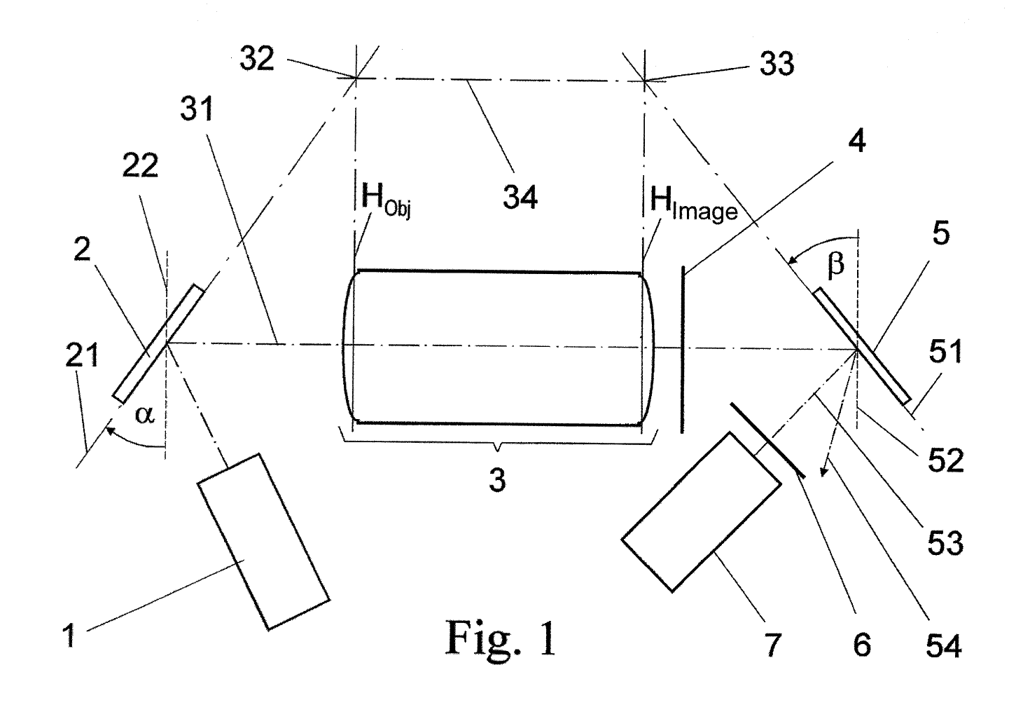

As can be seen from FIG. 1, the arrangement according to the invention basically comprises an illumination unit 1, an electro-optical matrix 2, an imaging optical system 3, an excitation filter 4, a specimen carrier 5 and a high-sensitivity detector unit 7 for the fluorescent radiation excited on-the specimen carrier and a blocking filter 6 which is arranged in front of the detector unit 7 and which is transparent to fluorescent radiation and not transparent to excitation radiation.

The illumination unit 1 supplies essentially collimated white light of high intensity and homogeneity. It illuminates the reflecting electro-optical matrix 2 over its entire surface. A selected wavelength region in which the fluorescing substances (known as markers) in the individual specimens of the specimen carrier 5 are optimally excited is adjustable by means of the exchangeable excitation filter 4.

The electro-optical matrix 2 acts as a matrix display which is switchable so as to reflect (or not reflect) by pixel and—for spatially differentiated illumination of the specimen carrier 5—is sharply imaged on the specimen carrier 5 by the imaging optical system 3. Since the specimen carrier 5 contains a plurality of individual specimens which are ordered metrically (in matrix shape) (a biochip will have a quantity of spots, as they are called, on the order of, e.g., 10⁴), the optical system 3 must ensure a highly precise correlation of luminous (bright-switched) pixels of the electro-optical matrix 2 to the individual specimens of the specimen carrier 5. This is carried out by means of a low-distortion, coma-free objective. Telecentric imaging systems, of which it is generally known that aberrations and distortion of the generated image are low, are best suited for this purpose.

In order to realize an incident darkfield illumination which, in itself, keeps diffraction components and scattered light components in the excitation light as small as possible, the electro-optical matrix 3 which is already also switchable in a spatially differentiated manner is illuminated by the incident light method.

Because of the required high resolution of the optical system 3, it is conventional—because of the short distances from the object plane and the image plane to the respective lens surface of the optical system 3—to couple in the darkfield illumination (e.g., in ring shape) via the optical system itself, so that the light arriving in the image plane leads to a direct illumination of the specimen carrier 5 in every case. For this reason, according to the invention, an inclined position of the specimen carrier 5 relative to the optical axis 31 of the optical system 2 is required, although the exact correlation of illumination pixels of the electro-optical matrix 2 to the individual specimens of the specimen carrier 5 (optically sharp imaging) conflicts with this, since there is a sharp imaging of the electro-optical matrix 2 only in the orthogonal plane 52.

Therefore, according to the invention, the specimen carrier 5 and the electro-optical matrix 2 are inclined in opposite directions relative to the optical axis 31 in order to achieve a Scheimpflug rectification of the image field distortion known from photographic technique. The condition to be used specifically for the invention in order to achieve the required pixel-exact allocation of the electro-optical matrix 2 and specimen carrier 5 is shown in FIG. 1. The angle of inclination α of the electro-optical matrix 2 relative to the orthogonal object plane 22 to the optical axis 31 is to be adapted to the angle of inclination β of the specimen carrier 5 in such a way that the section line 32 in which the inclined object plane 31 intersects the object-side principal plane H_{obj} of the optical system 3 and the section line 33 in which the image-side principal plane H_{Image} intersects the inclined image plane 51 lie in the same plane 34 parallel to the optical axis 31.

Under this boundary condition, the angles of inclination α and β can be selected in such a way that the light transmitted through the imaging optical system 3 is not reflected by the specimen carrier 5 in the direction of the detection beam path 53, but rather the bundle of the reflected excitation light 54 clearly travels past the detector unit 7. The blocking filter 6 arranged in front of the detector unit 7 accordingly has a blocking function only for scattered light components of the excitation light, so that the excitation light is kept away almost entirely from the detector unit 7.

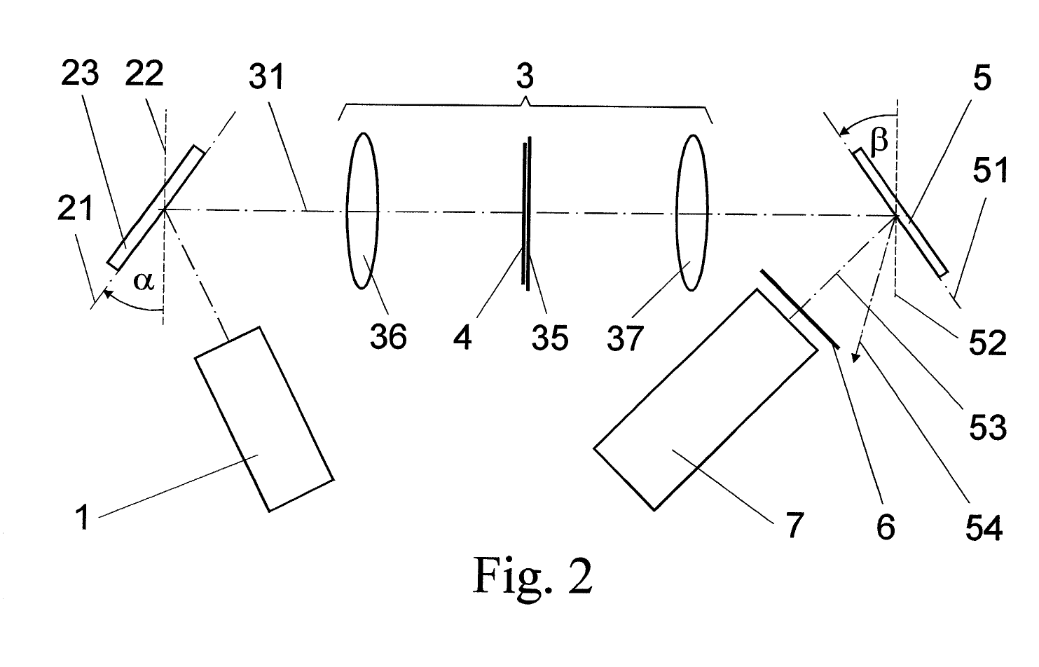

In an arrangement based on the principle shown schematically in FIG. 1, FIG. 2 shows schematically a suitable imaging optical system which is constructed from two identically constructed partial objectives 36 and 37 arranged in a mirror-symmetric manner. The aperture diaphragm plane 35 of the (total) optical system 3 which is telecentric on both sides is located in the center of the optical system 3. The imaging illumination beam path between the electro-optical matrix 2, which is realized in this case in the form of a liquid crystal matrix (LCD) 23, and the specimen carrier 5 is accordingly realized with an imaging scale of 1:−1 by means of a symmetrically constructed optical system 3 with angles of inclination α and β of the electro-optical matrix 2 and specimen carrier 5 which are of identical magnitude but are directed in opposite directions (β=−α). The angle of the darkfield illumination (corresponds to the angle of inclination β(=−α) by which the specimen carrier 5 and electro-optical matrix 2 are inclined relative to the optical axis 31 of the illumination beam path) can be optionally selected and can accordingly be adapted to the numerical aperture of the detector unit 7 (collecting optics 71 ) in the fluorescence detection beam path 53.

The optical system 3 which is constructed symmetrically from partial objectives 36 and 37 of identical construction ensures that the electro-optical matrix 2 is imaged on the specimen carrier 5 without coma and without distortion in a (1:−1) imaging scale. Further, due to the fact that the optical system 3 is telecentric on both sides, this special type of symmetric illumination beam path guarantees that defocusing will not cause any change in the imaging scale. A change in the imaging scale would be just as disadvantageous as distortion.

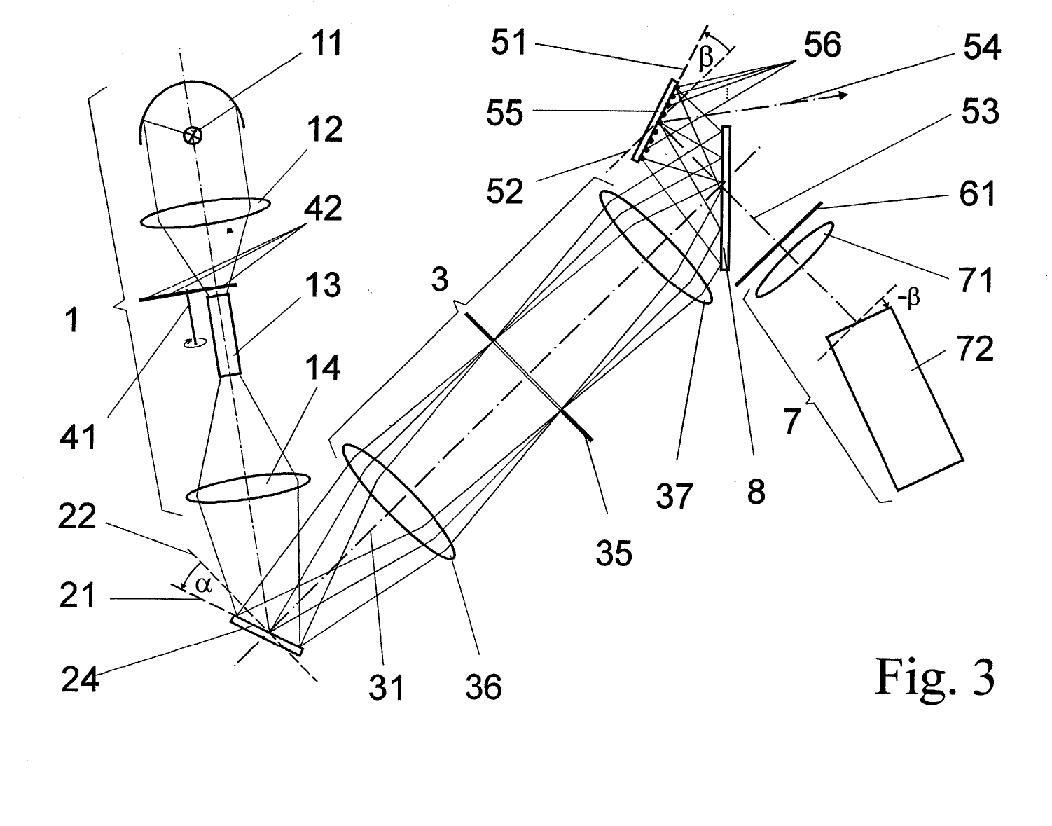

The preferred embodiment form of the invention shown in FIG. 3 makes use of the advantages and particulars of modem multimedia projectors (e.g., the “Astrobeam 530 S”). These multimedia projectors are outfitted with fast electro-optical matrices. A rotating color filter disk (with different color segments: blue, green, red and, if required, white) is located in the illumination beam path and rotates about its axis once on the order of 10 ms and is connected with the control circuit of the electro-optical matrix by synchronizing pulses. In a projector which is outfitted in this way, the illumination unit 1 has, successively, a reflector lamp 11, a collector 12, a light mixing rod 13 for homogenizing the light, and optics 14. Further, the efficient electro-optical matrix which is contained in a projector of this kind and which can be a liquid crystal matrix (LCD) 23 (as is shown in FIG. 2) or a digital micromirror matrix (DMD—digital micromirror device) 24, as is indicated in this construction according to FIG. 3, can be used together with the existing control circuit.

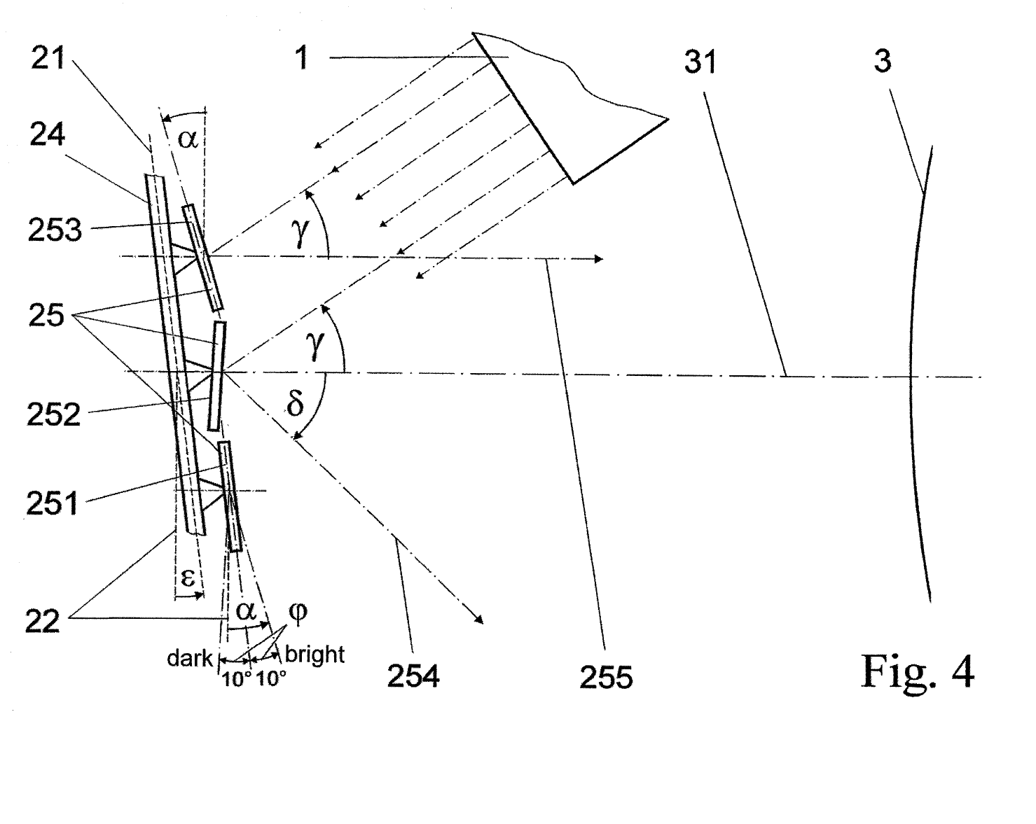

However, the micromirror matrix 24 (hereinafter DMD 24 ) must be suitably positioned in accordance with the basic principle described above. This can be achieved in an advantageous and economical manner by replacing the projector lens of a projector of this kind with a suitably dimensioned symmetrically constructed (1:−1) objective (preferably comprising two identically constructed powerful objectives such as Visionar® 1.9/141) and in that the optical system 3 used as a substitute is positioned so as to be tilted relative to the existing DMD 24 by the angle of inclination α. The angles of the optical axis 31 of the optical system 3 which are to be adjusted in relation to the angle of inclination ε of the DMD 24 and the angles of inclination of the elementary mirrors 25 are explained in more detail in the following with reference to the detail in FIG. 4 and the accompanying description for the use of a DMD 24.

The arrangement in FIG. 3 uses the illumination unit 1 taken in its entirety from a multimedia projector, but the standard color filters (green, blue, red and, if required, white) are either removed or are replaced by different excitation filters 42 which are arranged in the existing filter wheel 41. The first case, in which the filter wheel 41 is eliminated, is suitable for specimen carriers 5 which are only examined for one fluorescence marker. In this case, a suitable excitation filter 4 is arranged in an optional location in the imaging illumination beam path (e.g., according to FIG. 1 or 2 ). In the second case, when different excitation filters 42 are integrated in the filter wheel 41, different special fluorescence markers can be examined in the individual specimens 56 of the biochip 55, which is shown here schematically. This is advantageous particularly for analyzing biochips 55 which are labeled multiple times (i.e., provided with different fluorescence markers), since the existing filter wheel 41 is already synchronized with the DMD 24 for the conventional purposes of a multimedia projector in such a way that all filters of the filter wheel 41 are switched through once (one revolution of the filter wheel) after a switching pulse for switching the elementary mirrors 25 of the DMD 24 in a switching cycle. Accordingly, the product of the switching time of the electro-optical matrix 2 and the quantity of changes of the different excitation filters 42, which product limits the specimen throughput in conventional fluorescence analysis devices for multispecimen carriers (according to DE 199 14 279C1), is reduced exclusively to the switching time of the electro-optical matrix 2 (in this case, the DMD 24 ). Therefore, the quantity of necessary write-in (switching) processes for illumination patterns or models of the DMD 24 does not depend on the quantity of different fluorochromes in the biochip 55. The time expended on writing in an illumination model and for measuring the integral fluorescence intensity excited by this illumination model are approximately equal (e.g., 8 ms). Consequently, with three different dyes on the biochip 55, the ratio of the necessary processing times would be:

$$\frac{( \text{old method} )}{( \text{new method} )} = \frac{( 3 \times \text{write-in} + 3 \times \text{measurement} )}{( 1 \times \text{write-in} + 3 \times \text{measurement} )} \approx \frac{3}{2} .$$

For reading out biochip 55 with multicolor labeling, the conventional single-band blocking filter 6 must be replaced by corresponding multiband blocking filters 61 in the fluorescence detection beam path 53 so as to be adapted to the segments of the filter wheel 41 correspondingly replaced by different excitation filters 42.

As further modifications to FIGS. 1 and 2, the imaging illumination beam path in FIG. 3 is bent or angled through an additional beam splitter 8 after passing through the two partial objectives 36 and 37. The spatial coupling of the detector unit 7 is simplified and a spatial separation of the excitation light and fluorescent light is made possible when a dichroic splitter mirror which reflects the excitation light and is transparent to the fluorescent light is used as beam splitter 8. As an equivalent, it is also possible to illuminate the biochip 55 on the optical axis 31 in transmission through the beam splitter 8, in which case the beam splitter 8 then causes the deflection of the fluorescence detection beam path 53 when the beam splitter 8 is transparent to the excitation light and reflects the fluorescent light.

The light transmitted by the optical system 3 with an excitation wavelength (each of which is different from the preceding) is reflected, in the example according to FIG. 3, by the beam splitter 8 and sharply imaged on the biochip 55. Corresponding to the matrix elements which are controlled to bright on the DMD 24, only selected individual specimens (spots) 56 (possibly all of them in a combined manner individually in succession or by groups) of the biochip 55 are illuminated in a sharply defined manner. The excitation light 54 reflected according to the laws of reflection is deflected into a light trap at the edge of the beam splitter 8. All conventional methods can be used as possible light traps (see, for example, Naumann/Schröder, Bauelemente der Optik—Taschenbuch der Technischen Optik [Optical Components—Technical Optics Handbook], Carl Hanser Verlag, Munich, Vienna, 1992; pp 76 ff).

In order to detect the excited fluorescent radiation in the individual specimens 56 of the biochip 55, the detection beam path 53 uses the existing transmission characteristic of the dichroic beam splitter 8 for the fluorescence wavelengths by arranging the detector unit 7 on the other side of the optical axis 31 opposite the biochip 55. The biochip 55 is compulsorily inclined with respect to the axis of the detection beam path 53 passing through the beam splitter 8, so that a Scheimpflug rectification would also be useful in this case. For this purpose, the opto-electronic receiver which can advantageously be a high-sensitivity photodiode or a photon detector (PMT 72) would have to be arranged in the detection beam path 53 so as to be inclined in the opposite direction with respect to the biochip 53. Since an imaging scale not equal to 1:−1 is generally required in the detection beam path 53 in order to adapt the size of the image of the biochip 55 to the size of the light-sensitive surface of the PMT 72, only a relatively poor, distorted imaging of the biochip 55 can be realized in the receiver plane of the PMT 72 by means of the collecting optics 71. However, this is relatively unimportant since only integral intensities are acquired in the fluorescence detection beam path 53 (integrally over a fluorescing spot 56 or integrally over a group of spots 56 which are not necessarily contiguous) and no spatially resolved signal in the sense of an image of the biochip 55 is recorded (as is the case in the known CCD imager).

With respect to the advantages of a particularly high-contrast, spatially differentiated illumination and optically sharp imaging thereof by the darkfield method according to FIG. 3, a DMD 24 proves particularly advantageous and will therefore be described in detail with respect to the angular ratios in the inclination of the object plane 22. In this connection, FIG. 4 can be considered as a detail of the lower left-hand corner of FIG. 3 without any implied limitation that the DMD 24 could not also be used in FIGS. 1 and 2.

The DMD 24 comprises a matrix-shaped arrangement (17-μm grid dimension, for example) of a plurality (e.g., 800×600) of very small elementary mirrors 25 (16 μm×16 μm, for example) which can be deflected about their center into two possible positions. Of the large number of elementary mirrors 25, three of them are shown schematically in FIG. 4 in different positions. As can be gathered from the view of the elementary mirror 251 shown in a neutral position without power, the elementary mirrors are rotatable (e.g., by ±10°) about their diagonal. As relates to use, the rotation (tilting) of the elementary mirror 251 in the clockwise direction means bright switching and rotation in the opposite direction means dark switching. The currentless zero position corresponds to the parallel position of the elementary mirror 22 in relation to the base board of the DMD 24.

The elementary mirror 252 shows bright switching. For the arrangement according to the invention, this means that the DMD 24, as total element, is to be set up like a unitary mirror when the elementary mirror 25 is switched to bright. The angle of inclination a which is required for every elementary mirror 251, 252, 253 when switched to bright and which is to be adjusted in order to meet the Scheimpflug condition with respect to the biochip 55 does not match the angle for the alignment of the base board of the DMD 24 relative to the orthogonal plane 22; rather, it is an angle of inclination ε=α−φ that is reduced by the tilting angle φ (which is assumed, in this case, to be φ=10°). For the bright switching of elementary mirror 25, shown by way of example at elementary mirror 253, the incident angle γ of the excitation light of the illumination unit 1 relative to the optical axis 31 is selected in such a way that the reflected excitation bundle 254 enters the optical system 3 (shown only as a front lens surface) parallel to the optical axis 31.

At the same angle of incidence γ at which the excitation light coming from the illumination unit 1 impinges on the elementary mirror 252 which has been tilted out of its (currentless) rest position in the positive rotating direction by φ=10° (according to the example above for a DMD 24) into the dark position, resulting in an angular difference of 2φ=20° relative to elementary mirror 253, the reflected excitation bundle 255 has a reflection angle δ relative to the optical axis 31 which is 40 degrees greater than the excitation bundle 254 during bright switching (corresponds to δ=0°). Generally, this means that γ=2α,δ=4φ, where the double tilting angle |2φ| lies between the bright position and the dark position of the elementary mirror 25. The reflection angle δ which is accordingly considerably enlarged ensures that the excitation bundle 255 of the elementary mirror 252, shown by way of example, which is reflected in the dark position clearly lies outside the entrance aperture of the optical system 3, so that a matrix pixel in the form of elementary mirror 252 appears dark in the imaging beam path of the optical system 3 and an associated individual specimen (spot) 56 on the biochip 55 does not receive any fluorescence excitation from this matrix pixel of the DMD 24.

While the foregoing description and drawings represent the present invention, it will be obvious to those skilled in the art that various changes may be made therein without departing from the true spirit and scope of the present invention.

Reference Numbers

| | |
|---|---|
| 1 | illumination unit |
| 11 | reflector lamp |
| 12 | collector |
| 13 | light mixing rod |
| 14 | optics |
| 2 | electro-optical matrix |
| 21 | inclined object plane |
| 22 | orthogonal plane (to optical axis) |
| 23 | liquid crystal matrix (LCD) |
| 24 | digital-mechanical mirror matrix (DMD) |
| 25 | elementary mirror |
| 251 | elementary mirror (without power) |
| 252 | dark-switched elementary mirror |
| 253 | bright-switched elementary mirror |
| 254 | reflected excitation bundle (with dark switching) |
| 255 | reflected excitation bundle (with bright switching) |
| 3 | imaging optics |
| 31 | optical axis |
| 32, 33 | section lines |
| 34 | parallel plane (to optical axis) |
| 35 | aperture diaphragm |
| 36, 37 | (mirror-symmetric) partial objective |
| 4 | excitation filter |
| 41 | filter wheel |
| 42 | different excitation filter (in the filter wheel) |
| 5 | specimen carrier |
| 51 | inclined image plane |
| 52 | orthogonal image plane |
| 53 | detection beam path |
| 54 | reflected excitation light |
| 55 | biochip |
| 56 | individual specimen |
| 6 | blocking filter |
| 61 | multiband blocking filter |
| 7 | detector unit |
| 71 | collecting optics |
| 72 | PMT (photomultiplier) |
| 8 | deflecting mirror |
| α | angle of inclination of the object plane |
| β | angle of inclination of the image plane |
| γ | angle of incidence of the excitation light (relative to the |
| | optical axis) |
| δ | reflection angle (relative to the optical axis with dark switching) |
| ε | angle of inclination (of the DMD base board) |
| H_{Obj} | object-side image plane |
| H_{Image} | image-side image plane |

What is claimed is:

1. An arrangement for reading out the fluorescent radiation of specimen carriers with a plurality of individual specimens which for purposes of exciting fluorescent radiation in selected individual specimens comprises:
a switchable electro-optical matrix for generating illumination which is limited in a spatially defined manner;
an optical system for imaging the electro-optical matrix on the specimen carrier, wherein exchangeable excitation filters are arranged in the beam path in front of the specimen carrier for optimal excitation of fluorescence; and
a high-sensitivity photoreceiver for integral measurement of the fluorescent radiation of the excited individual specimens of the specimen carrier;
said electro-optical matrix being arranged in the object plane of the optical system and said specimen carrier being arranged in the image plane;
said electro-optical matrix and the specimen carrier being inclined relative to the optical axis of the optical system and are subject to a Scheimpflug condition, so that the object plane and object-side principal plane and the image plane and image-side principal plane of the optical system have two section lines lying in the same plane parallel to the optical axis; and
the angles of inclination of the electro-optical matrix and of the specimen carrier being selected such that the excitation radiation coming from the light source unit and reflected by the electro-optical matrix and imaged on the specimen carrier by the optical system is reflected at the specimen carrier in such a way that essentially no excitation radiation reaches the detection beam path.

2. The arrangement according to claim 1, wherein the imaging optical system comprises two identically constructed objectives which are arranged on the same optical axis and so as to be mirror-symmetric with respect to an aperture diaphragm plane, and the electro-optical matrix and the specimen carrier are arranged in a mirror-symmetric manner with respect to the two-part optical system.

3. The arrangement according to claim 2, wherein the symmetric optical system has an imaging beam path which is telecentric on both sides.

4. The arrangement according to claim 2, wherein the optical system comprises two high-resolution rapid objectives.

5. The arrangement according to claim 1, wherein the electro-optical matrix is a reflection liquid crystal matrix.

6. The arrangement according to claim 1, wherein the electro-optical matrix is a digital micromirror matrix comprising a plurality of elementary mirrors, wherein each of the elementary mirrors, as a unit, has a defined tilting angle for the reflection of light when an elementary mirror is switched to bright and another defined tilting angle for cutting out the radiation when an elementary mirror is switched to dark, and when the elementary mirrors are switched to bright the excitation bundle reflected by the digital micromirror matrix is directed parallel to the optical axis in the optical system.

7. The arrangement according to claim 1, wherein a beam splitter is arranged in the imaging beam path between the optical system and the specimen carrier, wherein the imaging beam path is directed to the specimen carrier in an angled manner, the excitation radiation is coupled out of the angled imaging beam path by reflection at the specimen carrier due to the inclination of the specimen carrier, and the excited fluorescent radiation can be picked up by the detector unit through the beam splitter.

8. The arrangement according to claim 7, wherein the beam splitter is a dichroic beam splitter which reflects excitation light and is transparent to fluorescent light.

9. The arrangement according to claim 1, wherein a beam splitter is arranged in the imaging beam path between the optical system and the specimen carrier, wherein the imaging beam path is directed along the optical axis to the specimen carrier, the excitation radiation is coupled out of the angled imaging beam path by reflection at the specimen carrier due to the inclination of the specimen carrier, and the excited fluorescent radiation is deflected by the beam splitter and can be recorded by the detector unit.

10. The arrangement according to claim 9, wherein the beam splitter is a dichroic beam splitter which is transparent to the excitation radiation and reflects the fluorescent radiation.

11. The arrangement according to claim 1, wherein the construction design of a multimedia projector is provided for realizing the illumination unit and electro-optical matrix and the optical system is used instead of a projection lens of the projector, wherein the inclination of the electro-optical matrix relative to the optical system is adjusted by means of the inclination of the optical system relative to the conventional position of the eliminated projection lens, and the specimen carrier which has a corresponding inclination relative to the electro-optical matrix in accordance with the Scheimpflug condition is arranged on the optical axis of the optical system.

12. The arrangement according to claim 11, wherein for purposes of evaluating specimen carriers provided with only one fluorescence marker, a filter wheel which is typically present in the illumination unit of the multimedia projector is removed from the beam path of the illumination unit.

13. The arrangement according to claim 9, wherein for purposes of evaluating specimen carriers which are marked multiple times with fluorescence markers, a filter wheel which is typically present in the illumination unit of the multimedia projector is outfitted with different excitation filters, wherein the different excitation filters are rotated successively into the beam path in a controlled cycle and a multiband blocking filter is inserted in front of the detector unit in the detection beam path.

14. The arrangement according to claim 11, wherein for purposes of evaluating specimen carriers which are marked multiple times with fluorescence markers, the filter wheel has a rotating speed such that a complete revolution is carried out synchronous with a switching state of the electro-optical matrix, and the readout of the detector unit is synchronized with individual filter states of the filter wheel i such a way that a series of measurements which are generated for identical individual specimens with different excitation filters is recorded in the detector unit.
